(19) United States
(12) Patent Application Publication
(10) Pub. No.: US 2014/0070709 A1
(43) Pub. Date: Mar. 13, 2014

(54) METHOD OF ARRANGING POWER-LINES FOR AN ORGANIC LIGHT EMITTING DISPLAY DEVICE, DISPLAY PANEL MODULE, AND ORGANIC LIGHT EMITTING DISPLAY DEVICE HAVING THE SAME

(71) Applicants: Hae-Yeon LEE, Yongin-City (KR); Young-In HWANG, Yongin-City (KR); Yong-Jae KIM, Yongin-City (KR); Wang-Jo LEE, Yongin-City (KR)

(72) Inventors: Hae-Yeon LEE, Yongin-City (KR); Young-In HWANG, Yongin-City (KR); Yong-Jae KIM, Yongin-City (KR); Wang-Jo LEE, Yongin-City (KR)

(21) Appl. No.: 13/912,165

(22) Filed: Jun. 6, 2013

(30) Foreign Application Priority Data
Sep. 11, 2012 (KR) 10-2012-0100226

(51) Int. Cl. H05B 33/08

(52) U.S. Cl. CPC H05B 33/0896
USPC 315/176; 29/825

(57) ABSTRACT

A method of arranging power-lines between a power supply circuit and a display panel in an organic light emitting display device, the method including: substantially symmetrically arranging first high power-lines between the power supply circuit and the display panel, the first high power-lines being configured to concurrently transmit a first high power voltage to first pixels; substantially symmetrically arranging second high power-lines outside of the first high power-lines between the power supply circuit and the display panel, the second high power-lines being configured to concurrently transmit a second high power voltage to second pixels; and substantially symmetrically arranging third high power-lines outside of the second high power-lines between the power supply circuit and the display panel, the third high power-lines being configured to concurrently transmit a third high power voltage to third pixels.

### CROSS-REFERENCE TO RELATED APPLICATION

This application claims priority under 35 USC §119 to and the benefit of Korean Patent Applications No. 10-2012-0100226, filed on Sep. 11, 2012 in the Korean Intellectual Property Office (KIPO), the contents of which are incorporated herein in its entirety by reference.

### BACKGROUND

1. Field

Example embodiments relate generally to an organic light emitting display device.

2. Description of the Related Art

Recently, an organic light emitting display device is widely used as a flat display device as electronic devices are manufactured to have smaller sizes and to consume less power. Generally, an organic light emitting display device implements (i.e., displays) a specific gray level using a voltage stored in a storage capacitor of each pixel (i.e., an analog driving technique for the organic light emitting display device). However, the analog driving technique may not accurately implement a desired gray level because the analog driving technique uses the voltage (i.e., an analog value) stored in the storage capacitor of each pixel. To overcome these problems, a digital driving technique for the organic light emitting display device has been suggested. In detail, the digital driving technique displays one frame by displaying a plurality of sub-frames. That is, the digital driving technique divides one frame into a plurality of sub-frames, differently sets respective emission times of the sub-frames (e.g., by a factor of 2), and implements a specific gray level using a sum of emission times of the sub-frames.

Typically, in the organic light emitting display device employing the digital driving technique, because a driving transistor of each pixel operates in a linear region, the driving transistor may act as a switching element. Thus, a current flowing through an organic light emitting diode of each pixel may be determined based on a voltage between two ends of the organic light emitting diode (i.e., a high power voltage ELVDD and a low power voltage ELVSS). For example, assuming that the low power voltage ELVSS is a ground voltage, the current may be determined based on the high power voltage ELVDD. Here, because the digital driving technique implements the specific gray level using the sum of the emission times of the sub-frames, the same high power voltage ELVDD_R (hereinafter, a red color high power voltage) should be applied to pixels representing a red color (hereinafter, red color pixels), the same high power voltage ELVDD_B (hereinafter, a blue color high power voltage) should be applied to pixels representing a blue color (hereinafter, blue color pixels), and the same high power voltage ELVDD_G (hereinafter, a green color high power voltage) should be applied to pixels representing a green color (hereinafter, green color pixels).

However, in the organic light emitting display device employing conventional digital driving techniques, an asymmetric voltage drop (i.e., IR-drop) may occur when the red color high power voltage ELVDD_R, the blue color high power voltage ELVDD_B, and the green color high power voltage ELVDD_G are transmitted from a power supply circuit to a display panel because an arrangement of power-lines for transmitting the red color high power voltage ELVDD_R, the blue color high power voltage ELVDD_B, and the green color high power voltage ELVDD_G from the power supply circuit to the display panel is complicated (i.e., complicatedly designed). Thus, depending on the location of the pixels (e.g., left location and right location) on the display panel, the red color pixels may receive different red color high power voltages ELVDD_R, the blue color pixels may receive different blue color high power voltages ELVDD_B, and the green color pixels may receive different green color high power voltages ELVDD_G. As a result, a display panel employing conventional digital driving techniques may display an image having a non-uniform luminance.

### SUMMARY

Some example embodiments provide a method of arranging power-lines capable of preventing (or reducing the occurrence of) an asymmetric voltage drop (i.e., IR-drop) when a red color high power voltage, a blue color high power voltage, and a green color high power voltage are transmitted from a power supply circuit to a display panel via power-lines in an organic light emitting display device.

Some example embodiments provide a display panel module capable of increasing a luminance uniformity (i.e., achieving a high luminance uniformity) by preventing an asymmetric voltage drop when a red color high power voltage, a blue color high power voltage, and a green color high power voltage are transmitted from a power supply circuit to a display panel via power-lines in an organic light emitting display device.

Some example embodiments provide an organic light emitting display device having the display panel module capable of outputting (i.e., displaying) a high-quality image.

According to some example embodiments, provided is a method of arranging power-lines between a power supply circuit and a display panel in an organic light emitting display device, the method including: substantially symmetrically arranging first high power-lines between the power supply circuit and the display panel, the first high power-lines being configured to concurrently transmit a first high power voltage to first pixels; substantially symmetrically arranging second high power-lines outside of the first high power-lines between the power supply circuit and the display panel, the second high power-lines being configured to concurrently transmit a second high power voltage to second pixels; and substantially symmetrically arranging third high power-lines outside of the second high power-lines between the power supply circuit and the display panel, the third high power-lines being configured to concurrently transmit a third high power voltage to third pixels.

In example embodiments, the method may further include substantially symmetrically arranging low power-lines between the power supply circuit and the display panel, the low power-lines being configured to concurrently transmit a low power voltage to the first through third pixels.

In example embodiments, the low power-lines may be arranged inside of the first high power-lines.

In example embodiments, the low power-lines may be arranged outside of the third high power-lines.

In example embodiments, the first pixels, the second pixels, and the third pixels may correspond to blue color pixels configured to emit a blue color light, green color pixels configured to emit a green color light, and red color pixels configured to emit a red color light, respectively.

In example embodiments, the first high power voltage, the second high power voltage, and the third high power voltage may be different from each other.

According to some example embodiments, a display panel module may include a display panel having first pixels, second pixels, and third pixels, at least one data driving integrated circuit configured to provide a data signal for the first through third pixels to the display panel, at least one scan driving integrated circuit configured to provide a scan signal for the first through third pixels to the display panel, and at least one power supply circuit configured to provide a low power voltage, a first high power voltage, a second high power voltage, and a third high power voltage for the first through third pixels, respectively, to the display panel, the first high power voltage, the second high power voltage, and the third high power voltage being different from each other. Here, first high power-lines for transmitting the first high power voltage, second high power-lines for transmitting the second high power voltage, and third high power-lines for transmitting the third high power voltage may be substantially symmetrically arranged between the power supply circuit and the display panel.

In example embodiments, low power-lines for transmitting the low power voltage may be substantially symmetrically arranged between the power supply circuit and the display panel.

In example embodiments, the second high power-lines may be arranged outside of the first high power-lines, and the third high power-lines may be arranged outside of the second high power-lines.

In example embodiments, the low power-lines may be arranged inside of the first high power-lines.

In example embodiments, the low power-lines may be arranged outside of the third high power-lines.

In example embodiments, the first pixels, the second pixels, and the third pixels may correspond to blue color pixels configured to emit a blue color light, green color pixels configured to emit a green color light, and red color pixels configured to emit a red color light, respectively.

In example embodiments, the data driving integrated circuit, the scan driving integrated circuit, and the power supply circuit may be coupled to the display panel by a chip-on flexible printed circuit, a chip-on glass, or a flexible printed circuit.

According to some example embodiments, an organic light emitting display device may include a display panel having first pixels, second pixels, and third pixels, a data driving unit having at least one data driving integrated circuit configured to provide a data signal for the first through third pixels to the display panel, a scan driving unit having at least one scan driving integrated circuit configured to provide a scan signal for the first through third pixels to the display panel, a power supply unit having at least one power supply circuit configured to provide a low power voltage, a first high power voltage, a second high power voltage, and a third high power voltage for the first through third pixels to the display panel, the first high power voltage, the second high power voltage, and the third high power voltage being different from each other, and a timing control unit configured to control the data driving unit, the scan driving unit, and the power supply unit. Here, first high power-lines for transmitting the first high power voltage, second high power-lines for transmitting the second high power voltage, and third high power-lines for transmitting the third high power voltage may be substantially symmetrically arranged between the power supply circuit and the display panel.

In example embodiments, low power-lines for transmitting the low power voltage may be substantially symmetrically arranged between the power supply circuit and the display panel.

In example embodiments, the second high power-lines may be arranged outside of the first high power-lines, and the third high power-lines may be arranged outside of the second high power-lines.

In example embodiments, the low power-lines may be arranged inside of the first high power-lines.

In example embodiments, the low power-lines may be arranged outside of the third high power-lines.

In example embodiments, the first pixels, the second pixels, and the third pixels may correspond to blue color pixels configured to emit a blue color light, green color pixels configured to emit a green color light, and red color pixels configured to emit a red color light, respectively.

In example embodiments, the data driving integrated circuit, the scan driving integrated circuit, and the power supply circuit may be coupled to the display panel by a chip-on flexible printed circuit, a chip-on glass, or a flexible printed circuit.

Therefore, a method of arranging power-lines according to example embodiments may prevent (or substantially prevent) an asymmetric voltage drop (i.e., IR-drop) when a red color high power voltage, a blue color high power voltage, and a green color high power voltage are transmitted from a power supply circuit to a display panel via power-lines in an organic light emitting display device by substantially symmetrically arranging the power-lines for transmitting the red color high power voltage, the blue color high power voltage, and the green color high power voltage from the power supply circuit to the display panel.

In addition, a display panel module according to example embodiments may transmit a red color high power voltage, a blue color high power voltage, and a green color high power voltage from a power supply circuit to a display panel via power-lines that are substantially symmetrically arranged. As a result, the display panel module may increase a luminance uniformity (i.e., achieve a high luminance uniformity) by preventing (or substantially preventing) an asymmetric voltage drop when the red color high power voltage, the blue color high power voltage, and the green color high power voltage are transmitted from the power supply circuit to the display panel.

Further, an organic light emitting display device having the display panel module according to example embodiments may output (i.e., display) a high-quality image.

### BRIEF DESCRIPTION OF THE DRAWINGS

Illustrative, non-limiting example embodiments will be more clearly understood from the following detailed description taken in conjunction with the accompanying drawings.

FIG. 1 is a flow chart illustrating a method of arranging power-lines for an organic light emitting display device according to example embodiments.

FIG. 2A is a diagram illustrating an example in which power-lines are symmetrically arranged between a power supply circuit and a display panel by the method of FIG. 1.

FIG. 2B is a diagram illustrating another example in which power-lines are symmetrically arranged between a power supply circuit and a display panel by the method of FIG. 1.

FIG. 3 is a diagram illustrating a display panel module that is designed by the method of FIG. 1.

FIG. 4 is a diagram illustrating one region of a display panel module that is designed by the method of FIG. 1.

FIG. 5 is a diagram illustrating an example in which power-lines are arranged between a power supply circuit and a display panel in an organic light emitting display device employing conventional digital driving techniques.

FIG. 6 is a diagram illustrating an asymmetric voltage drop that is caused by an arrangement of power-lines of FIG. 5.

FIG. 7 is a diagram illustrating an example in which power-lines are arranged between a power supply circuit and a display panel in an organic light emitting display device by the method of FIG. 1.

FIG. 8 is a diagram illustrating a symmetric voltage drop that is caused by an arrangement of power-lines of FIG. 7.

FIG. 9 is a block diagram illustrating an organic light emitting display device according to example embodiments.

FIG. 10 is a block diagram illustrating an electronic device having an organic light emitting display device of FIG. 9.

### DETAILED DESCRIPTION OF EMBODIMENTS

Various example embodiments will be described more fully hereinafter with reference to the accompanying drawings, in which some example embodiments are shown. The present inventive concept may, however, be embodied in many different forms and should not be construed as limited to the example embodiments set forth herein. Rather, these example embodiments are provided so that this disclosure will be thorough and complete, and will fully convey the scope of the present inventive concept to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

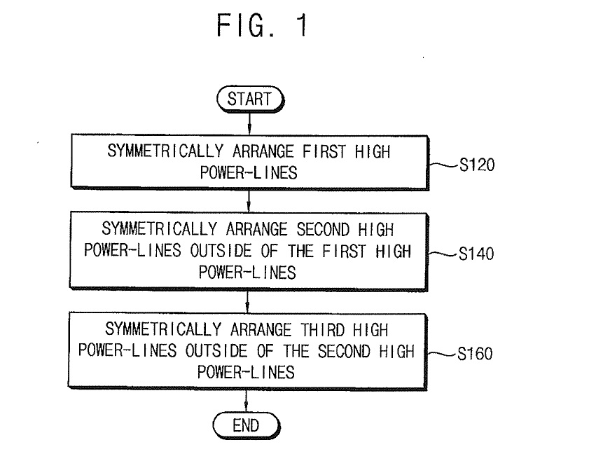

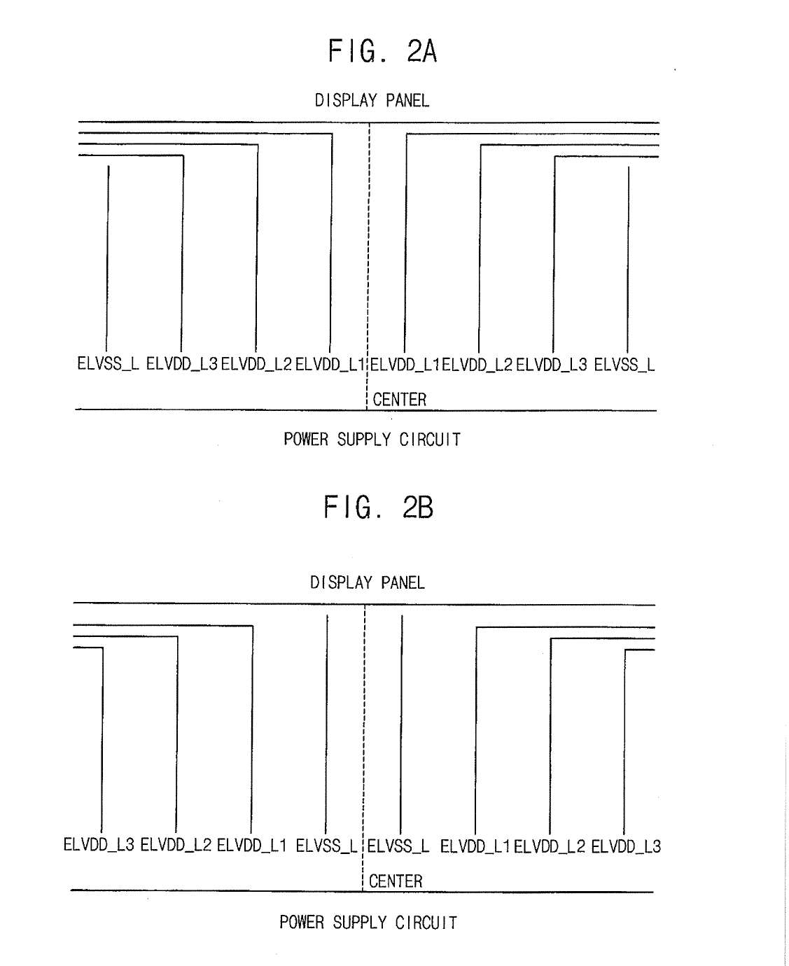

FIG. 1 is a flow chart illustrating a method of arranging power-lines for an organic light emitting display device according to example embodiments. FIG. 2A is a diagram illustrating an example in which power-lines are symmetrically arranged between a power supply circuit and a display panel by a method of FIG. 1. FIG. 2B is a diagram illustrating another example in which power-lines are symmetrically arranged between a power supply circuit and a display panel by a method of FIG. 1.

Referring to FIGS. 1, 2A, and 2B, when arranging a plurality of power-lines between a power supply circuit and a display panel in an organic light emitting display device, the method of FIG. 1 may include symmetrically (or substantially symmetrically) arranging a plurality of first high power-lines ELVDD_L1 between a display panel and a power supply circuit, the first high power lines ELVDD_1 being configured to concurrently (e.g., simultaneously or substantially simultaneously) transmit or supply a first high power voltage to a plurality of first pixels (Step S120).

The method of FIG. 1 may further include symmetrically (or substantially symmetrically) arranging a plurality of second high power-lines ELVDD_L2 between a display panel and a power supply circuit, with the second high power lines ELVDD_L2 being configured to concurrently (e.g., simultaneously or substantially simultaneously) transmit or supply a second high power voltage to a plurality of second pixels outside of the first high power-lines ELVDD_L1 (Step S140).

The method of FIG. 1 may further include symmetrically (or substantially symmetrically) arranging a plurality of third high power-lines ELVDD_L3 between a display panel and a power supply circuit, with the third high power lines ELVDD_L3 being configured to concurrently (e.g., simultaneously or substantially simultaneously) transmit or supply a third high power voltage to a plurality of third pixels outside of the second high power-lines ELVDD_L2 (Step S160). For convenience of descriptions, a reference-line CENTER for symmetrically arranging the first through third high power-lines ELVDD_L1, ELVDD_L2, and ELVDD_L3 is illustrated in FIGS. 2A and 2B.

In an organic light emitting display device employing conventional digital driving techniques, an arrangement of power-lines for transmitting a first high power voltage (e.g., a blue color high power voltage ELVDD_B), a second high power voltage (e.g., a green color high power voltage ELVDD_G), and a third high power voltage (e.g., a red color high power voltage ELVDD_R) from the power supply circuit to the display panel is complicated (i.e., complicatedly designed). For example, because the first high power-lines ELVDD_L1 for transmitting the first high power voltage, the second high power-lines ELVDD_L2 for transmitting the second high power voltage, and the third high power-lines ELVDD_L3 for transmitting the third high power voltage are sequentially arranged in the organic light emitting display device employing the conventional digital driving techniques, slender (i.e., thin, slim) bridge-lines need to be arranged to extend across the reference-line CENTER in order to symmetrically transmit the first and third high power voltages from both regions divided by the reference-line CENTER to the display panel. Here, an asymmetric voltage drop may occur when the first through third high power voltages are transmitted via the slender bridge-lines because a relatively large current flows through the slender bridge-lines having a relatively high resistance.

Thus, in the organic light emitting display device employing the conventional digital driving techniques, depending on the location of the pixels (e.g., left location and right location) on the display panel, first pixels (e.g., red color pixels) may receive different first high power voltages (e.g., red color high power voltages), second pixels (e.g., blue color pixels) may receive different second high power voltages (e.g., blue color high power voltages), and third pixels (e.g., green color pixels) may receive different third high power voltages (e.g., green color high power voltages). As a result, conventional digital driving techniques may cause the display panel in the organic light emitting display device to display a non-uniform luminance.

To overcome these problems, the method of FIG. 1 may include symmetrically (or substantially symmetrically) arranging the first high power-lines ELVDD_L1 between the display panel and the power supply circuit, with the first high power lines ELVDD_L1 being configured to concurrently (e.g., simultaneously or substantially simultaneously) transmit or supply the first high power voltage to a plurality of first pixels (Step S120). As illustrated in FIGS. 2A and 2B, the first high power-lines ELVDD_L1 may be symmetrically (or substantially symmetrically) arranged with respect to the reference-line

CENTER. For example, the first pixels may correspond to the blue color pixels representing a blue color, the green color pixels representing a green color, or the red color pixels representing a red color. Assuming that the first pixels correspond to the blue color pixels, the first high power voltage (e.g., the blue color high power voltage ELVDD_B) may be transmitted or supplied via the first high power-lines ELVDD_L1.

In addition, the method of FIG. 1 may include symmetrically (or substantially symmetrically) arranging the second high power-lines ELVDD_L2 between the display panel and the power supply circuit, with the second high power lines ELVDD_L2 being configured to concurrently (e.g., simultaneously or substantially simultaneously) transmit or supply the second high power voltage to a plurality of second pixels outside of the first high power-lines ELVDD_L1 (Step S140).

As illustrated in FIGS. 2A and 2B, the second high power-lines ELVDD_L2 may also be symmetrically arranged with respect to the reference-line CENTER, and the second high power-lines ELVDD_L2 may be arranged outside of the first high power-lines ELVDD_L1. For example, the second pixels may correspond to the blue color pixels, the green color pixels, or the red color pixels. Assuming that the second pixels correspond to the green color pixels, the second high power voltage (e.g., the green color high power voltage ELVDD_G) may be transmitted via the second high power-lines ELVDD_L2.

Further, the method of FIG. 1 may include symmetrically (or substantially symmetrically) arranging the third high power-lines ELVDD_L3 between a display panel and a power supply circuit, the third high power-lines ELVDD_L3 being configured to concurrently (e.g., simultaneously or substantially simultaneously) transmit or supply the third high power voltage to the third pixels outside of the second high power-lines ELVDD_L2 (Step S160). As illustrated in FIGS. 2A and 2B, the third high power-lines ELVDD_L3 may also be symmetrically arranged with respect to the reference-line CENTER, and the third high power-lines ELVDD_L3 may be arranged outside of the second high power-lines ELVDD_L2. For example, the third pixels may correspond to the blue color pixels, the green color pixels, or the red color pixels. Assuming that the third pixels correspond to the red color pixels, the third high power voltage (e.g., the red color high power voltage ELVDD_R) may be transmitted via the third high power-lines ELVDD_L3.

In example embodiments, the method of FIG. 1 may also include symmetrically (or substantially symmetrically) arranging low power-lines ELVSS_L between a display panel and a power supply circuit, the low power-lines ELVSS_L being configured to concurrently (e.g., simultaneously or substantially simultaneously) transmit a low power voltage ELVSS to the first through third pixels. In one example embodiment, as illustrated in FIG. 2A, the low power-lines ELVSS_L may be arranged outside of the third high power-lines ELVDD_L3. In another example embodiment, as illustrated in FIG. 2B, the low power-lines ELVSS_L may be arranged inside of the first high power-lines ELVDD_L1.

In an organic light emitting display device employing a digital driving technique, because a driving transistor of each pixel operates in a linear region, a current flowing through an organic light emitting diode of each pixel may be determined based on a voltage between two ends of the organic light emitting diode (i.e., a high power voltage ELVDD and a low power voltage ELVSS). For example, assuming that the low power voltage ELVSS is a ground voltage, the current may be determined based on the high power voltage ELVDD. Hence, the first high power voltage supplied to the first pixels, the second high power voltage supplied to the second pixels, and the third high power voltage supplied to the third pixels may be different from each other. For example, when the same high power voltage is supplied, a luminance of the red color pixels may be lower than a luminance of the green color pixels, and the luminance of the green color pixels may be lower than a luminance of the blue color pixels. Thus, the red color high power voltage ELVDD_R supplied to the red color pixels may be greater than the green color high power voltage ELVDD_G supplied to the green color pixels, and the green color high power voltage ELVDD_G supplied to the green color pixels may be greater than the blue color high power voltage ELVDD_B supplied to the blue color pixels. The first through third high power voltages may be variously determined according to required conditions for the organic light emitting display device. The low power voltage ELVSS supplied to the first through third pixels may be a ground voltage. However, the low power voltage ELVSS supplied to the first through third pixels is not limited thereto.

As described above, the method of FIG. 1 may prevent or substantially prevent an asymmetric voltage drop when the first through third high power voltages are transmitted from the power supply circuit to the display panel by symmetrically arranging the first through third high power-lines ELVDD_L1, ELVDD_L2, and ELVDD_L3 for transmitting the first through third high power voltage, respectively, from the power supply circuit to the display panel in the organic light emitting display device.

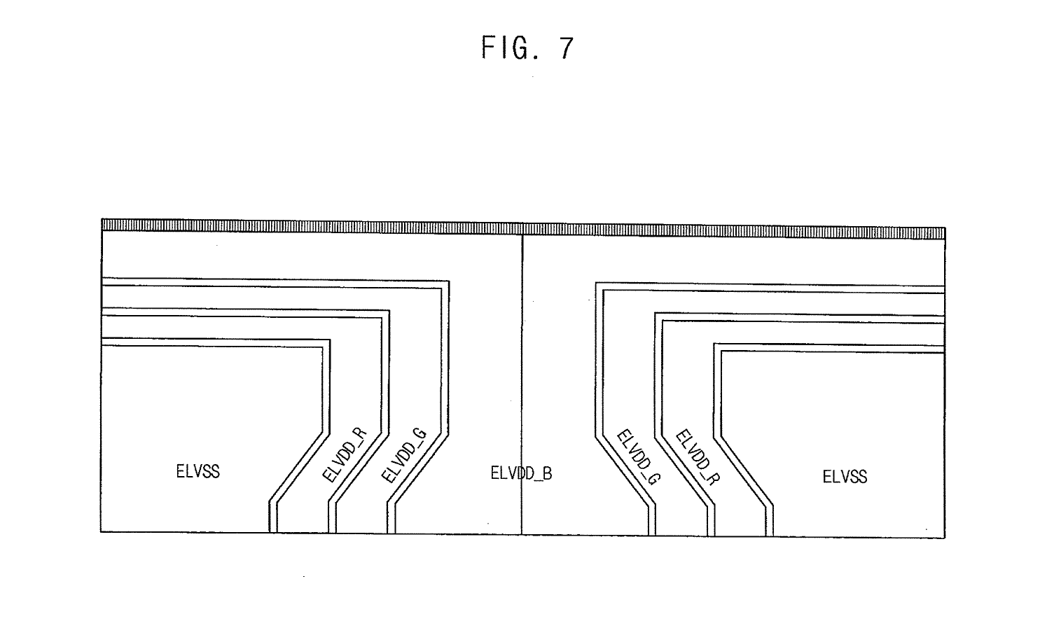

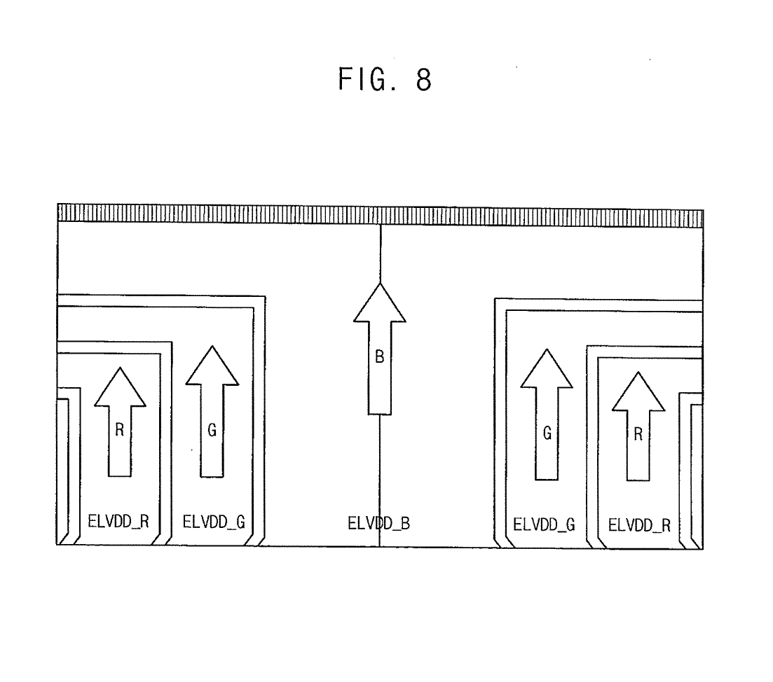

Although not illustrated in FIGS. 2A and 2B, the first through third high power voltages may be transmitted to the first through third pixels, respectively, via internal power-lines of the display panel after the first through third high power voltages are transmitted to the display panel via the first through third high power-lines ELVDD_L1, ELVDD_L2, and ELVDD_L3, respectively. In addition, as not illustrated in FIGS. 2A and 2B, the low power voltage ELVSS may be concurrently (e.g. simultaneously or substantially simultaneously) applied to a cathode of respective organic light emitting diodes of the first through third pixels after the low power voltage ELVSS is transmitted to the display panel via the low power-lines ELVSS_L. Exemplary arrangements of the first through third high power-lines ELVDD_L1, ELVDD_L2, and ELVDD_L3 and the low power-lines ELVSS_L between the power supply circuit and the display panel will be described with reference to FIGS. 7 and 8.

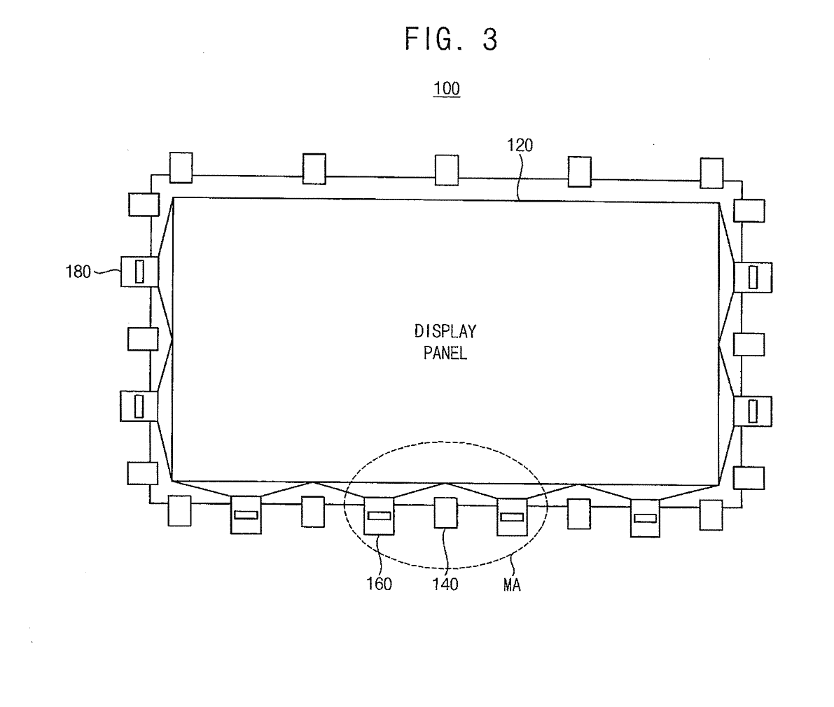

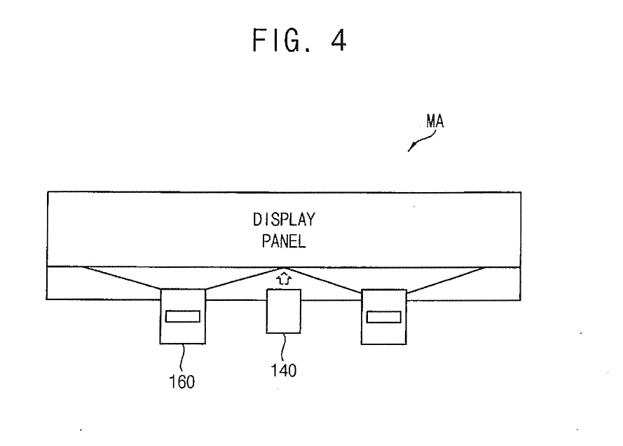

FIG. 3 is a diagram illustrating a display panel module that is designed according to the method of FIG. 1. FIG. 4 is a diagram illustrating one region of a display panel module that is designed according to the method of FIG. 1.

Referring to FIGS. 3 and 4, the display module 100 may include a display panel 120, at least one power supply circuit 140, at least one data driving integrated circuit (IC) 160, and at least one scan driving integrated circuit (IC) 180. In one example embodiment, the power supply circuit 140, the data driving IC 160, and the scan driving IC 180 may be coupled to the display panel 120 by a chip-on flexible printed circuit (COF), a chip-on glass (COG), a flexible printed circuit (FPC), etc.

The display panel 120 may include first pixels that are configured to concurrently (e.g., simultaneously or substantially simultaneously) receive a first high power voltage, second pixels that are configured to concurrently (e.g., simultaneously or substantially simultaneously) receive a second high power voltage, and third pixels that are configured to concurrently (e.g., simultaneously or substantially simultaneously) receive a third high power voltage. Here, the first through third pixels may also be configured to concurrently (e.g., simultaneously or substantially simultaneously) receive a low power voltage. Thus, a current flowing through respective organic light emitting diodes of the first pixels may be determined based on the first high power voltage and the low power voltage, a current flowing through respective organic light emitting diodes of the second pixels may be determined based on the second high power voltage and the low power voltage, and a current flowing through respective organic light emitting diodes of the third pixels may be determined based on the third high power voltage and the low power voltage.

As described above, a digital driving technique for an organic light emitting display device divides one frame into a plurality of sub-frames, differently sets respective emission times of the sub-frames (e.g., by a factor of 2), and implements a specific gray level using a sum of emission times of the sub-frames. Hence, it should be understood that the first high power voltage supplied to the first pixels, the second high power voltage supplied to the second pixels, and the third high power voltage supplied to the third pixels are not changed (i.e., not adjusted) for respective pixels. In example embodiments, the first pixels, the second pixels, and the third pixels may correspond to blue color pixels representing a blue color, green color pixels representing a green color, and red color pixels representing a red color. For example, the first pixels may correspond to the blue color pixels, the second pixels may correspond to the green color pixels, and the third pixels may correspond to the red color pixels.

The power supply circuit 140 may supply the first through third high power voltages and the low power voltage to the display panel 120. Here, the first high power voltage for the first pixels, the second high power voltage for the second pixels, and the third high power voltages for the third pixels may be different from each other. For example, when the same high power voltage is supplied, a luminance of the red color pixels, a luminance of the green color pixels, and a luminance of the blue color pixels may be different from each other. For example, the luminance of the red color pixels may be lower than the luminance of the green color pixels, and the luminance of the green color pixels may be lower than the luminance of the blue color pixels. Thus, the power supply circuit 140 may supply the red color high power voltage ELVDD_R to the red color pixels, may supply the green color high power voltage ELVDD_G to the green color pixels, and may supply the blue color high power voltage ELVDD_B to the blue color pixels. Here, the red color high power voltage ELVDD_R may be greater than the green color high power voltage ELVDD_G, and the green color high power voltage ELVDD_G may be greater than the blue color high power voltage ELVDD_B.

The first through third high power voltages may be variously determined according to required conditions for the organic light emitting display device. Meanwhile, the first high power-lines for transmitting the first high power voltage may be symmetrically arranged between the power supply circuit 140 and the display panel 120, the second high power-lines for transmitting the second high power voltage may be symmetrically arranged between the power supply circuit 140 and the display panel 120, and the third high power-lines for transmitting the third high power voltage may be symmetrically arranged between the power supply circuit 140 and the display panel 120.

In detail, the second high power-lines may be symmetrically arranged outside of the first high power-lines between the power supply circuit 140 and the display panel 120. Similarly, the third high power-lines may be symmetrically arranged outside of the second high power-lines between the power supply circuit 140 and the display panel 120. In addition, the low power-lines may be symmetrically arranged between the power supply circuit 140 and the display panel 120. In one example embodiment, the low power-lines may be arranged inside of the first high power-lines between the power supply circuit 140 and the display panel. In another example embodiment, the low power-lines may be arranged outside of the third high power-lines between the power supply circuit 140 and the display panel. Because these are described in reference to FIGS. 2A and 2B, duplicated descriptions will be omitted. The data driving IC 160 may provide a data signal for the first through third pixels to the display panel 120. The scan driving IC 180 may provide a scan signal for the first through third pixels to the display panel 120. Therefore, the display panel 120 may display an image based on the first through third high power voltage and the low power voltage provided from the power supply circuit 140, the data signal provided from the data driving IC 160, and the scan signal provided from the scan driving IC 180.

It is illustrated in FIG. 3 that the display panel module 100 includes a plurality of power supply circuits 140 at a left side, a right side, an upper side, and a lower side of the display panel 120, a plurality of data driving ICs 160 at the lower side of the display panel 120, and a plurality of scan driving ICs 180 at the left side and the right side of the display panel 120. However, a structure of the display panel module 100 is not limited thereto. For example, a location of the power supply circuits 140 and a quantity of the power supply circuits 140 may be variously changed according to required conditions for the display panel module 100, a location of the data driving ICs 160 and a quantity of the data driving ICs 160 may be variously changed according to required conditions for the display panel module 100, and a location of the scan driving ICs 180 and a quantity of the scan driving ICs 180 may be variously changed according to required conditions for the display panel module 100. In addition, FIG. 4 shows one region MA of the display panel module 120. As illustrated in FIG. 4, the power supply circuit 140 may be located between the data driving ICs 160.

In conclusion, embodiments of the present invention may include symmetrically arranging the power-lines between the display panel 120 and the power supply circuits 140 (e.g., the power supply circuits 140 at the left side of the display panel 120, the power supply circuits 140 at the right side of the display panel 120, the power supply circuits 140 at the upper side of the display panel 120, and the power supply circuits 140 at the lower side of the display panel 120).

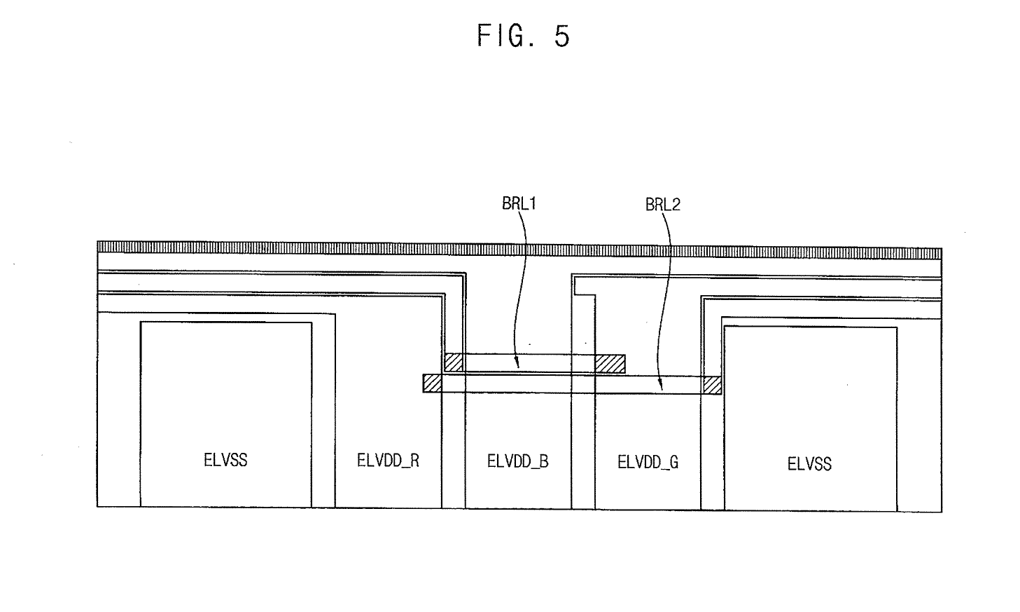

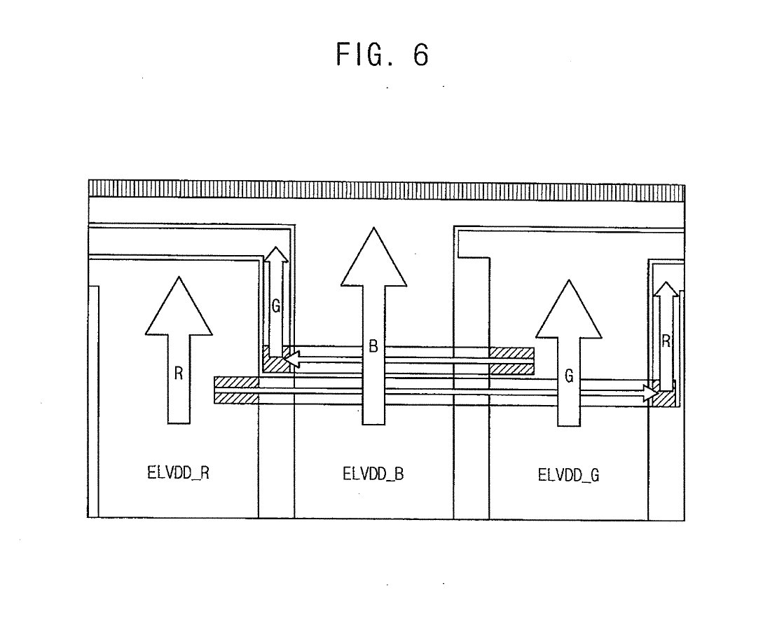

FIG. 5 is a diagram illustrating an example in which power-lines are arranged between a power supply circuit and a display panel in an organic light emitting display device employing conventional digital driving techniques. FIG. 6 is a diagram illustrating an asymmetric voltage drop that is caused by an arrangement of power-lines of FIG. 5.

Referring to FIGS. 5 and 6, power-lines may be complicatedly designed (i.e., arranged) between a power supply circuit and a display panel in an organic light emitting display device employing conventional digital driving techniques. As a result, an asymmetric voltage drop may be caused by a complicate arrangement of the power-lines. In other words, as illustrated in FIG. 5, because red color high power-lines for transmitting the red color high power voltage ELVDD_R, blue color high power-lines for transmitting the blue color high power voltage ELVDD_B, and green color high power-lines for transmitting the green color high power voltage ELVDD_G are sequentially arranged in the organic light emitting display device employing the conventional digital driving techniques, slender bridge-lines BRL1 and BRL2 may need to be arranged across a reference-line in order to symmetrically transmit the red color high power voltage ELVDD_R, the blue color high power voltage ELVDD_B, and the green color high power voltage ELVDD_G to the display panel. However, as illustrated in FIG. 6, an asymmetric voltage drop may occur when some high power voltages (e.g., the red color high power voltage ELVDD_R and the green color high power voltage ELVDD_G in FIG. 5) are transmitted via the slender bridge-lines BRL1 and BRL2 because a relatively large current flows through the slender bridge-lines BRL1 and BRL2, which have a relatively high resistance. As a result, display panels in organic light emitting display devices employing conventional digital driving techniques may have pixels or sub-pixels that emit light with a non-uniform luminance (e.g., left-right luminance deviation may occur). That is, the display panels (or the pixels or sub-pixels within the display panels) may not emit light with a uniform intensity.

FIG. 7 is a diagram illustrating an example in which power-lines are arranged between a power supply circuit and a display panel in an organic light emitting display device by a method according to FIG. 1. FIG. 8 is a diagram illustrating a symmetric voltage drop that is caused by an arrangement of power-lines of FIG. 7.

Referring to FIGS. 7 and 8, an asymmetric voltage drop may be prevented (or substantially prevented) because the power-lines are symmetrically (or substantially symmetrically) arranged between the power supply circuit and the display panel in the organic light emitting display device by the method according to FIG. 1. That is, as illustrated in FIG. 7, blue color high power-lines for transmitting a blue color high power voltage ELVDD_B, green color high power-lines for transmitting a green color high power voltage ELVDD_G, and red color high power-lines for transmitting a red color high power voltage ELVDD_R may be symmetrically arranged in the organic light emitting display device. Specifically, the green color high power-lines may be arranged outside of the blue color high power-lines between the power supply circuit and the display panel, and the red color high power-lines are arranged outside of the green color high power-lines between the power supply circuit and the display panel.

Although it is illustrated in FIG. 7 that low power-lines for transmitting a low power voltage ELVSS from the power supply circuit to the display panel are arranged outside of the red color high power-lines, the low power-lines may be arranged inside of the blue color high power-lines. As a result, as illustrated in FIG. 8, the organic light emitting display device may not need slender bridge-lines for transmitting the red color high power voltage ELVDD_R, the blue color high power voltage ELVDD_B, and the green color high power voltage ELVDD_G from the power supply circuit to the display panel. On this basis, the organic light emitting display device may increase a luminance uniformity (i.e., may achieve a high luminance uniformity) by preventing the asymmetric voltage drop when the red color high power voltage ELVDD_R, the blue color high power voltage ELVDD_B, and the green color high power voltage ELVDD_G are transmitted from the power supply circuit to the display panel.

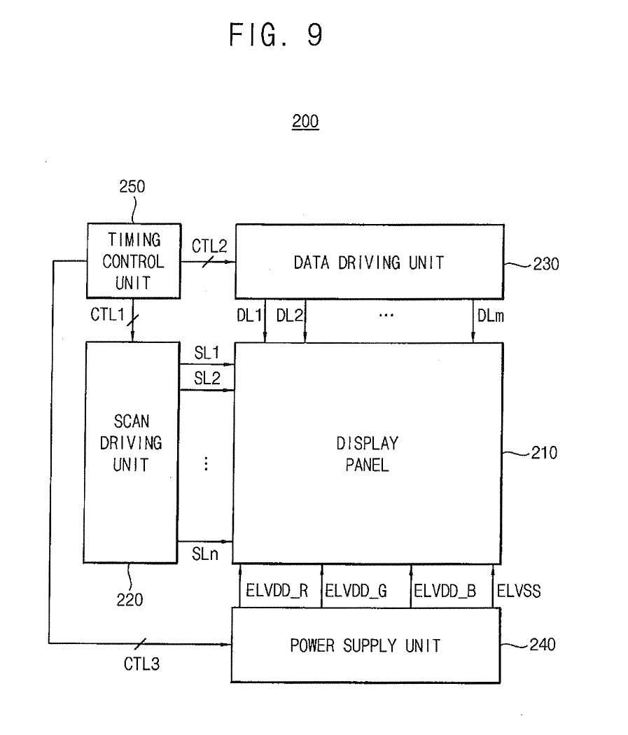

FIG. 9 is a block diagram illustrating an organic light emitting display device according to example embodiments.

Referring to FIG. 9, the organic light emitting display device 200 may include a display panel 210, a scan driving unit 220, a data driving unit 230, a power supply unit 240, and a timing control unit 250.

The display panel 210 may include first pixels that concurrently (e.g., simultaneously or substantially simultaneously) receive a first high power voltage ELVDD_B, second pixels that concurrently (e.g., simultaneously or substantially simultaneously) receive a second high power voltage ELVDD_G, and third pixels that concurrently (e.g., simultaneously or substantially simultaneously) receive a third high power voltage ELVDD_R. Additionally, the first through third pixels may concurrently (e.g., simultaneously or substantially simultaneously) receive a low power voltage ELVSS. Thus, a current flowing through respective organic light emitting diodes of the first pixels may be determined based on the first high power voltage ELVDD_B and the low power voltage ELVSS, a current flowing through respective organic light emitting diodes of the second pixels may be determined based on the second high power voltage ELVDD_G and the low power voltage ELVSS, and a current flowing through respective organic light emitting diodes of the third pixels may be determined based on the third high power voltage ELVDD_R and the low power voltage ELVSS.

A digital driving technique for the organic light emitting display device 200 divides one frame into a plurality of sub-frames, differently sets respective emission times of the sub-frames (e.g., by a factor of 2), and implements a specific gray level using a sum of emission times of the sub-frames. Hence, it should be understood that the first high power voltage ELVDD_B supplied to the first pixels, the second high power voltage ELVDD_G supplied to the second pixels, and the third high power voltage ELVDD_R supplied to the third pixels are not changed (i.e., not adjusted) for respective pixels. In example embodiments, the first pixels, the second pixels, and the third pixels may correspond to blue color pixels representing or emitting a blue color, green color pixels representing or emitting a green color, and red color pixels representing or emitting a red color. For example, the first pixels may correspond to the blue color pixels, the second pixels may correspond to the green color pixels, and the third pixels may correspond to the red color pixels.

The scan driving unit 220 may provide a scan signal to the display panel 210 via a plurality of scan-lines SL1 through SLn. The scan driving unit 220 may include at least one scan driving integrated circuit (IC). Here, the scan driving IC may be located near at least one side of the display panel 210. In addition, the scan driving IC may be coupled to the display panel 210 by a chip-on flexible printed circuit (COF), a chip-on glass (COG), a flexible printed circuit (FPC), etc. The data driving unit 230 may provide a data signal to the display panel 210 via a plurality of data-lines DL1 through DLm. The data driving unit 230 may include at least one data driving integrated circuit (IC). Here, the data driving IC may be located near at least one side of the display panel 210. In addition, the data driving IC may be coupled to the display panel 210 by a chip-on flexible printed circuit (COF), a chip-on glass (COG), a flexible printed circuit (FPC), etc. The power supply unit 240 may provide the first through third high power voltages ELVDD_B, ELVDD_G, and ELVDD_R and the low power voltage ELVSS to the display panel 210. The power supply unit 240 may include at least one power supply circuit. Here, the first high power voltage ELVDD_B supplied to the first pixels, the second high power voltage ELVDD_G supplied to the second pixels, and the third high power voltage ELVDD_R supplied to the third pixels may be different from each other. In addition, the low power voltage ELVSS may be a ground voltage. The timing control unit 250 may generate a plurality of control signals CTL1, CTL2, and CTL3, and may provide the control signals CTL1, CTL2, and CTL3 to the scan driving unit 220, the data driving unit 230, and the power supply unit 240 to control the scan driving unit 220, the data driving unit 230, and the power supply unit 240.

The power supply circuit of the power supply unit 240 may be located near at least one side of the display panel 210. Here, the power-lines for transmitting the first through third high power voltages ELVDD_B, ELVDD_G, and ELVDD_R from the power supply circuit of the power supply unit 240 to the display panel 210 may be symmetrically arranged. That is, the first high power-lines for transmitting the first high power voltage ELVDD_B from the power supply circuit of the power supply unit 240 to the display panel 210 may be symmetrically arranged, the second high power-lines for transmitting the second high power voltage ELVDD_G from the power supply circuit of the power supply unit 240 to the display panel 210 may be symmetrically arranged, and the third high power-lines for transmitting the third high power voltage ELVDD_R from the power supply circuit of the power supply unit 240 to the display panel 210 may be symmetrically arranged. Specifically, the second high power-lines may be arranged outside of the first high power-lines between the power supply circuit of the power supply unit 240 and the display panel 210, and the third high power-lines may be arranged outside of the second high power-lines between the power supply circuit of the power supply unit 240 and the display panel 210. In addition, the low power-lines may be symmetrically arranged between the power supply circuit of the power supply unit 240 and the display panel 210. In one example embodiment, the low power-lines may be arranged inside of the first high power-lines between the power supply circuit of the power supply unit 240 and the display panel 210. In another example embodiment, the low power-lines may be arranged outside of the third high power-lines between the power supply circuit of the power supply unit 240 and the display panel 210. Because these are described above, duplicated descriptions will be omitted.

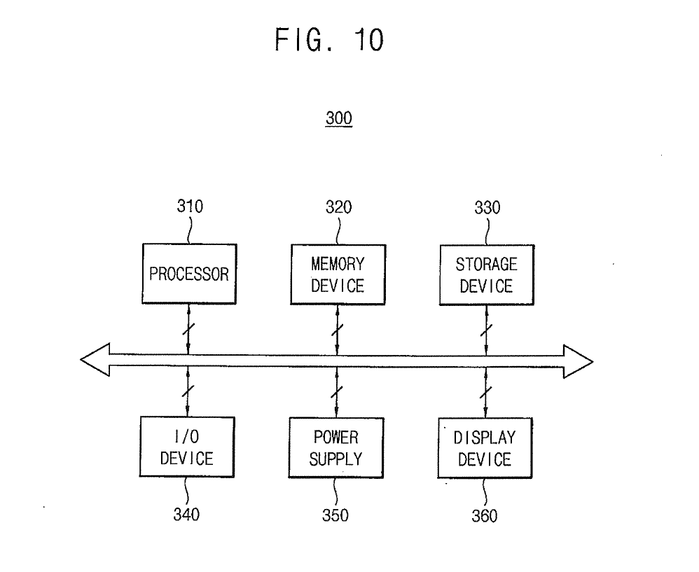

FIG. 10 is a block diagram illustrating an electronic device having an organic light emitting display device of FIG. 9.

Referring to FIG. 10, the electronic device 300 may include a processor 310, a memory device 320, a storage device 330, an input/output (I/O) device 340, a power supply 350, and an organic light emitting display device 360. Here, the organic light emitting display device 360 may correspond to the organic light emitting display device 200 of FIG. 9. In addition, the electronic device 300 may further include a plurality of ports for communicating a video card, a sound card, a memory card, a universal serial bus (USB) device, other electronic devices, etc.

The processor 310 may perform various computing functions. The processor 310 may be a microprocessor, a central processing unit (CPU), etc. The processor 310 may be coupled to other components via an address bus, a control bus, a data bus, etc. Further, the processor 310 may be coupled to an extended bus such as a peripheral component interconnection (PCI) bus. The memory device 320 may store data for operations of the electronic device 300. For example, the memory device 320 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc., and/or at least one volatile memory device such as a dynamic random access memory (DRAM) device, a static random access memory (SRAM) device, a mobile DRAM device, etc. The storage device 330 may be a solid state drive (SSD) device, a hard disk drive (HDD) device, a CD-ROM device, etc.

The I/O device 340 may be an input device such as a keyboard, a keypad, a touchpad, a touch-screen, a mouse, etc., and an output device such as a printer, a speaker, etc. In some example embodiments, the organic light emitting display device 360 may be included in the I/O device 340. The power supply 350 may provide a power for operations of the electronic device 300. The organic light emitting display device 360 may communicate with other components via the buses or other communication links. In one example embodiment, the organic light emitting display device 360 may employ a digital driving technique (i.e., may operate based on a digital driving technique). The organic light emitting display device 360 may include a display panel, a scan driving unit, a data driving unit, a power supply unit, a timing control unit, etc. Here, power-lines for transmitting a first high power voltage (e.g., a blue color high power voltage ELVDD_B), a second high power voltage (e.g., a green color high power voltage ELVDD_G), and a third high power voltage (e.g., a red color high power voltage ELVDD_R) from the power supply unit (i.e., at least one power supply circuit included in the power supply unit) to the display panel are symmetrically (or substantially symmetrically) arranged. As a result, the organic light emitting display device 360 may prevent (or substantially prevent) an asymmetric voltage drop when the blue color high power voltage ELVDD_B, the green color high power voltage ELVDD_G, and the red color high power voltage ELVDD_R are transmitted from the power supply unit to the display panel. Therefore, the organic light emitting display device 360 may output (i.e., display) a high-quality image because a luminance uniformity of the display panel is greatly improved.

Embodiments of the present invention may be applied to an electronic device having an organic light emitting display device. For example, embodiments of the present invention may be applied to a television, a computer monitor, a laptop, a digital camera, a cellular phone, a smart phone, a smart pad, a personal digital assistant (PDA), a portable multimedia player (PMP), a MP3 player, a navigation system, a game console, a video phone, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims and their equivalents. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims and their equivalents.

What is claimed is:

1. A method of arranging power-lines between a power supply circuit and a display panel in an organic light emitting display device, the method comprising:
substantially symmetrically arranging first high power-lines between the power supply circuit and the display panel, the first high power-lines being configured to concurrently transmit a first high power voltage to first pixels;
substantially symmetrically arranging second high power-lines outside of the first high power-lines between the power supply circuit and the display panel, the second high power-lines being configured to concurrently transmit a second high power voltage to second pixels; and
substantially symmetrically arranging third high power-lines outside of the second high power-lines between the power supply circuit and the display panel, the third high power-lines being configured to concurrently transmit a third high power voltage to third pixels.

2. The method of claim 1, further comprising:
substantially symmetrically arranging low power-lines between the power supply circuit and the display panel, the low power-lines being configured to concurrently transmit a low power voltage to the first through third pixels.

3. The method of claim 2, wherein the low power-lines are arranged inside of the first high power-lines.

4. The method of claim 2, wherein the low power-lines are arranged outside of the third high power-lines.

5. The method of claim 1, wherein the first pixels, the second pixels, and the third pixels correspond to blue color pixels configured to emit a blue color light, green color pixels configured to emit a green color light, and red color pixels configured to emit a red color light, respectively.

6. The method of claim 5, wherein the first high power voltage, the second high power voltage, and the third high power voltage are different from each other.

7. A display panel module comprising:
a display panel having first pixels, second pixels, and third pixels;
at least one data driving integrated circuit configured to provide a data signal for the first through third pixels to the display panel;
at least one scan driving integrated circuit configured to provide a scan signal for the first through third pixels to the display panel; and
at least one power supply circuit configured to provide a low power voltage, a first high power voltage, a second high power voltage, and a third high power voltage for the first through third pixels, respectively, to the display panel, the first high power voltage, the second high power voltage, and the third high power voltage being different from each other,
wherein first high power-lines for transmitting the first high power voltage, second high power-lines for transmitting the second high power voltage, and third high power-lines for transmitting the third high power voltage are substantially symmetrically arranged between the power supply circuit and the display panel.

8. The module of claim 7, wherein low power-lines for transmitting the low power voltage are substantially symmetrically arranged between the power supply circuit and the display panel.

9. The module of claim 8, wherein the second high power-lines are arranged outside of the first high power-lines, and the third high power-lines are arranged outside of the second high power-lines.

10. The module of claim 9, wherein the low power-lines are arranged inside of the first high power-lines.

11. The module of claim 9, wherein the low power-lines are arranged outside of the third high power-lines.

12. The module of claim 7, wherein the first pixels, the second pixels, and the third pixels correspond to blue color pixels configured to emit a blue color light, green color pixels configured to emit a green color light, and red color pixels configured to emit a red color light, respectively.

13. The module of claim 12, wherein the data driving integrated circuit, the scan driving integrated circuit, and the power supply circuit are coupled to the display panel by a chip-on flexible printed circuit, a chip-on glass, or a flexible printed circuit.

14. An organic light emitting display device comprising:
a display panel having first pixels, second pixels, and third pixels;
a data driving unit having at least one data driving integrated circuit configured to provide a data signal for the first through third pixels to the display panel;
a scan driving unit having at least one scan driving integrated circuit configured to provide a scan signal for the first through third pixels to the display panel;
a power supply unit having at least one power supply circuit configured to provide a low power voltage, a first high power voltage, a second high power voltage, and a third high power voltage for the first through third pixels to the display panel, the first high power voltage, the second high power voltage, and the third high power voltage being different from each other; and
a timing control unit configured to control the data driving unit, the scan driving unit, and the power supply unit,
wherein first high power-lines for transmitting the first high power voltage, second high power-lines for transmitting the second high power voltage, and third high power-lines for transmitting the third high power voltage are substantially symmetrically arranged between the power supply circuit and the display panel.

15. The device of claim 14, wherein low power-lines for transmitting the low power voltage are substantially symmetrically arranged between the power supply circuit and the display panel.

16. The device of claim 15, wherein the second high power-lines are arranged outside of the first high power-lines, and the third high power-lines are arranged outside of the second high power-lines.

17. The device of claim 16, wherein the low power-lines are arranged inside of the first high power-lines.

18. The device of claim 16, wherein the low power-lines are arranged outside of the third high power-lines.

19. The device of claim 14, wherein the first pixels, the second pixels, and the third pixels correspond to blue color pixels configured to emit a blue color light, green color pixels configured to emit a green color light, and red color pixels configured to emit a red color light, respectively.

20. The device of claim 19, wherein the data driving integrated circuit, the scan driving integrated circuit, and the power supply circuit are coupled to the display panel by a chip-on flexible printed circuit, a chip-on glass, or a flexible printed circuit.
